(19) United States
(12) Patent Application Publication
(10) Pub. No.: US 2007/0273146 A1
(43) Pub. Date: Nov. 29, 2007

(54) Security Device

(75) Inventors: Sharon Christine Davis, Hampshire (GB); Anita Marie Barthram, Berkshire (GB)

Correspondence Address: OLIFF & BERRIDGE, PLC, P.O. BOX 19928, ALEXANDRIA, VA, 22320, US

(73) Assignee: DE LA INTERNATIONAL LIMITED, Basingstoke, Hampshire (GB)

(21) Appl. No.: 10/584,846

(22) PCT Filed: Feb. 18, 2005
(86) PCT No.: PCT/GB05/00580

§ 371 Date: Jul. 27, 2006

(30) Foreign Application Priority Data
Feb. 20, 2004 (GB) 0403845.1

(51) Int. Cl. B42D 15/10

(52) U.S. Cl. 283/91; 283/72

(57) ABSTRACT

A security device comprises a substrate (40) having a reflective portion which is provided with a raised line, structure (6), the line structure defining a plurality of segments (4a, 5a . . . ), each segment being formed by a respective set of substantially parallel raised lines. The Mines of at least three segments extend in different directions. Each line is formed by or carries an ink (7) which does not extend fully into the spaces (8) between the lines or which is sufficiently translucent between the lines so as not to obscure the reflective surface between the lines, wherein each segment causes incident light to be reflected non-diffractively in a variable manner as the angle of incidence changes.

The invention relates to a security device and a method for making such a security device. The invention is particularly concerned with security devices for documents of value such as banknotes, certificates and the like.

It is well known to provide security devices in the form of holograms and diffraction gratings using surface relief structures. However, an alternative class of security device is based on non-diffractive line structures, that is structures which produce an optically variable effect when the angle of incidence of light varies but in which this effect is not caused by interference or diffraction.

An example of such a structure is described in WO 94/29119. In this case, a variety of line structures are embossed into a transparent, plastics substrate, the embossed lines defining regions in which the lines extend at different angles to each other and define different shapes that are visible to a greater or lesser extent upon transmission and reflection of light as the substrate such as a banknote is tilted, rotated or viewed from different angles.

WO 90/02658 describes a security device in which one or more transitory images are embossed into a reflective surface.

WO 98/20382 discloses a further security device in which groups of elemental areas in which lines extend at different angles from each other form respective image pixels.

Finally, U.S. Pat. No. 1,996,539 discloses a decorative device in which a relief structure is formed in a surface and has an optically variable effect.

There is a need to improve upon the known devices to increase their security.

In accordance with a first aspect of the present invention, a security device comprises a substrate having a reflective surface portion which is provided with a raised line structure, the line structure defining a plurality of segments, each segment being formed by a respective set of substantially parallel raised lines, the lines of at least three segments extending in different directions, each line carrying an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.

In accordance with a second aspect of the present invention, a method of manufacturing a security device comprises providing a reflective surface portion of a substrate with a raised line structure, the line structure defining a plurality of segments, each segment being formed by a respective set of substantially parallel raised lines, the lines of at least five segments extending in different directions, and providing each line with an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.

Thus, as the device is tilted relative to the incident light and angle of view it will exhibit optically variable effects.

The invention provides a security device which presents a moving effect viewable across a wide range of angles (in contrast to the limited angles over which a conventional latent image is viewable). It is simple to authenticate yet difficult to counterfeit. It is also surprisingly visible from a distance due to the reflective background.

The use of 3 or more segments enables a movement effect to be achieved. Ideally, many segments should be used with lines extending in different directions to ensure that reflected light is visible at substantially all viewing angles. To that end segments containing lines extending at say 10, 20, 30 etc to some nominal direction are preferred.

The lines are preferably embossed or debossed into the substrate. The embossing process is preferably carried out using an intaglio plate having recesses defining the line structure which are filled with the ink so that the lines and ink are simultaneously provided in register.

However, in an alternative approach, the lines of ink could be printed onto the unembossed reflective surface which is subsequently embossed in register. The former approach is preferred since registration is more simply achieved.

The invention also extends to non-embossed raised lines produced for example by screen or thermographic printing. Here an ink film is applied in such a thickness that it has a relief, in the case of UV printed screen inks this could be comparable to depth of relief achievable by intaglio.

The lines within each segment can take any convenient form including straight (rectilinear) or curved such as full or partial arcs of a circle or sections of a sinusoidal wave.

The lines may be continuous or discontinuous and, for example, formed of dashes, dots or other shapes. By other shapes we mean the dots or dashes could have a graphical form. For example microtext printed at a size of 12 microns will appear as continuous lines when viewed with the naked eye. Under closer inspection using an eye glass the apparent continuous line can be visualised as text. The microtext could be alphanumeric characters, logos (e.g. trademarks), geometric shapes and the like.

The sides of the lines typically extend at an angle offset from a normal to the surface.

The lines within a segment typically have substantially the same width and/or height and/or pitch but one or more of these could vary.

A particularly preferred example involves providing a region in the security device which has greater relief when printed. This is typically achieved by using an intaglio printing plate which is deeper in this region than the remainder of the plate.

The line widths are typically in the range 10-300 microns, preferably 50-150 microns. The space between the lines is typically 10-300 microns. The line width to space ratio is typically 3:1 to 1:2 but preferably 2:1; i.e. for a line width of 70 microns, the space would be between 23 and 140 microns, preferably 35 microns.

The line segments may or may not be, individually discernable to the unaided naked eye. Preferably, the individual lines are barely visible to the naked eye, the main visual impression being given by the segments and the combined effect thereof.

Each segment can take any shape or form, for example square, triangle, hexagon, star, flower or indicia such as a letter or number. The segments may tessellate or nest.

In some cases, the segments may be outlined with a continuous printed or non-printed perimeter line or the outline may simply be defined by the extent of the raised lines, preferably carrying ink. The continuous printed or non-printed line may define information such as indicia.

The segments will typically abut although in some cases they may be spaced apart. The space between adjacent segments is typically in the range of 20 microns to 2 mm. Alternatively, the segments could overlap and in a particularly preferred approach the segments are nested one within another. This latter arrangement is particularly preferred where each segment defines a similar shape. In the most preferred example, the nested segments are rotated relative to one another.

In another example, the segments within the security device define a range of different shapes and, for example, might comprise a combination of triangles and rhombi.

Additionally, the unprinted areas within one or more segments could define additional information such as alphanumerics. The alphanumerics could relate to information elsewhere on the document.

Where the segments are spaced apart, the plain areas between them may be of a similar shape to that of the segments.

The segments may also be arranged into larger shapes including, for example, geometric shapes, flowers, numbers or letters.

The specularly reflective portion of the substrate may be formed by a foil, metallic ink, metallic coating, iridescent coating, glossy varnish, hologram, high refractive index or optical effect film. By optical effect film we mean for example multilayer iridescent film. The reflective surface portion can be solid or discontinuous and, for example, may contain spaces with or without a coloured print underneath. It may be of any shape or size.

Typically, the specularly reflecting portion can be any colour, for example metallic blue, metallic red, silver or gold, and where specularly reflecting inks are used, these will generally give a general appearance, which is not as highly reflecting as a foil or other specular mirror surface but a distinctive sheen.

The raised line structure may extend beyond the reflective portion and/or the reflective portion may extend beyond the raised line structure.

The substrate is typically paper although other known substrates such as plastics could also be used. It is known that an improved reflective effect (whether this be via printing or foil transfer) can be achieved on a smooth substrate. With this in mind plastic substrates are likely to show a strong reflective effect but are less likely to emboss as well as paper. As an alternative a paper substrate could be primed to improve its surface finish. By priming we mean the paper could be coated, varnished or calendared prior to application of a reflective ink/foil layer. As a further alternative the foil/reflective ink could be calendered after application to the paper surface. This has a polishing effect again improving the reflectivity of the metallic surface. This polishing will occur to some extent anyway as part of the intaglio process. Where the flat smooth, uninked areas of the intaglio plate come into contact with the reflective foil/ink they polish the foil/inks surface.

In an important aspect, where the lines are formed using an intaglio plate, further intaglio printing or blind embossing may be carried out using the same intaglio plate so as to achieve precise registration between the different components. Indeed, in some cases, some of the recesses defining the security device may be filled with ink and others left unfilled.

The colour of the ink or pigment used on the raised lines may match the colour of the specularly reflective surface. Preferably, however, the colour of the ink or pigment contrasts with that of the specularly reflective surface. The advantage of this is that as the viewing angle and/or illumination angle changes, different segments become more strongly visible. This leads to the appearance of having two or more different colours simultaneously and is a very cost effective way of achieving an optically variable effect.

It is possible to achieve additional effects by combining accurately, one or more colours in the form of an ink with the raised lines in such a way that the reflective portions of the lines which are not covered by the coloured ink provide an optically variable effect in conjunction with the absorptive/reflective effect of the coloured ink. Thus, the colour of the ink can be used to change the overall appearance of the (specularly) reflective background. For example, a green ink could be printed over a silver background to create the effect of having a green specularly reflective surface.

In preferred examples using embossed or debossed line structures, the ink is provided on the lines and does not extend into the spaces between the lines. However, it is possible for the ink to extend between the lines if it is sufficiently thin so as to be translucent.

In accordance with a further aspect of the present invention, a security device comprises a substrate having a reflective surface portion which is provided with a raised (preferably embossed or debossed) line structure, the line structure defining a plurality of segments, each segment being formed by a respective set of substantially parallel raised lines, the lines of at least three segments extending in different directions, wherein each segment causes incident light to be reflected non-diffractively in a variable manner as the angle of incidence changes.

In this aspect of the invention, the raised lines remain uninked but, by providing at least three segments with lines extending in different directions, a secure device is achieved.

The security device may be embodied as a label such as a transfer label which can then be adhered to a document of value. Alternatively, the substrate of the security device could also constitute the substrate of a document of value.

Some examples of security devices according to the invention will now be described with reference to the accompanying drawings, in which:—

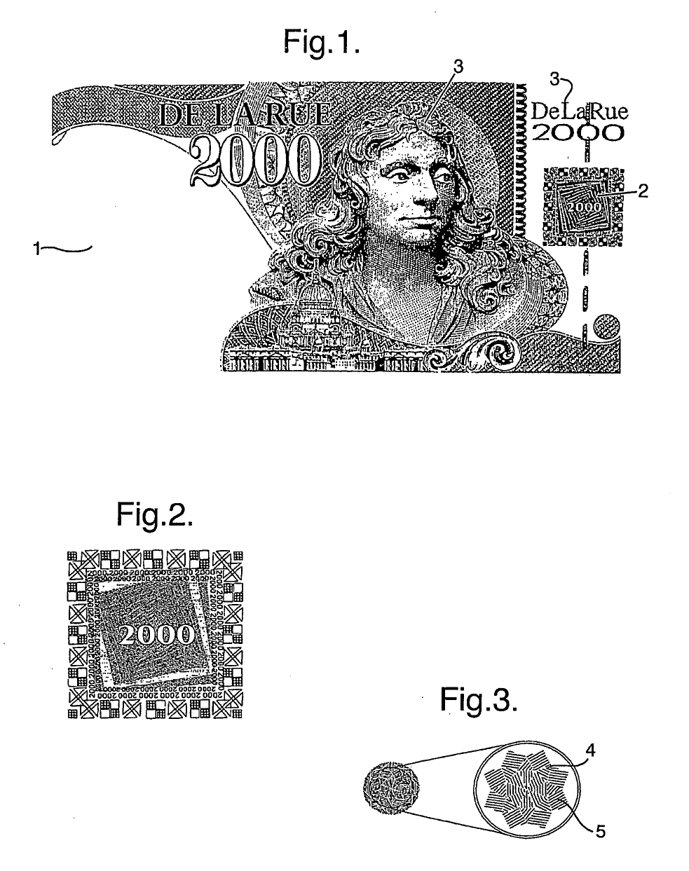

FIG. 1 is a schematic representation of a banknote bearing a security device according to the invention;

FIG. 2 illustrates schematically and in enlarged form part of the security device shown in FIG. 1;

FIG. 3 illustrates schematically and in enlarged form part of a further security device;

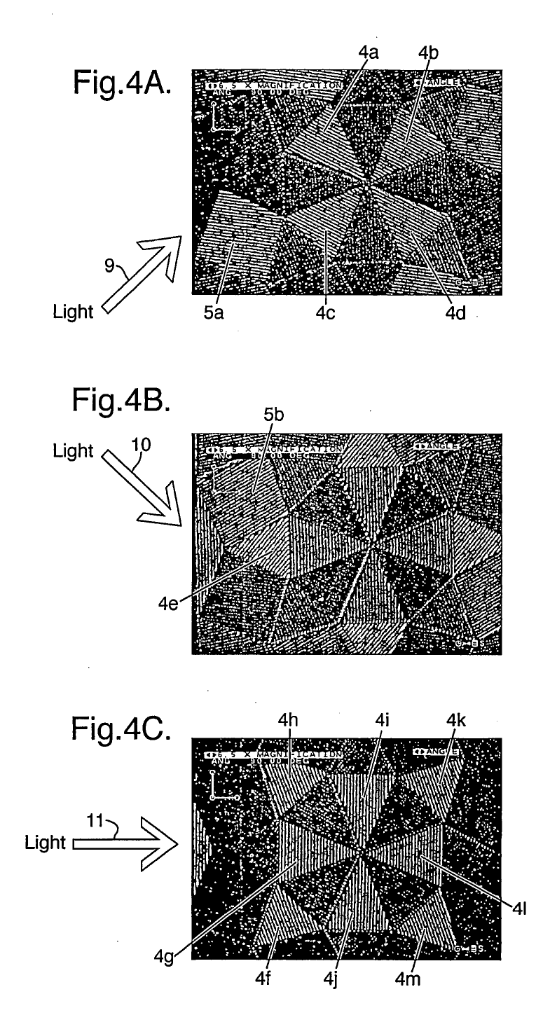

FIGS. 4A-4C illustrate the appearance of the security device of FIG. 3 when illuminated from three different directions;

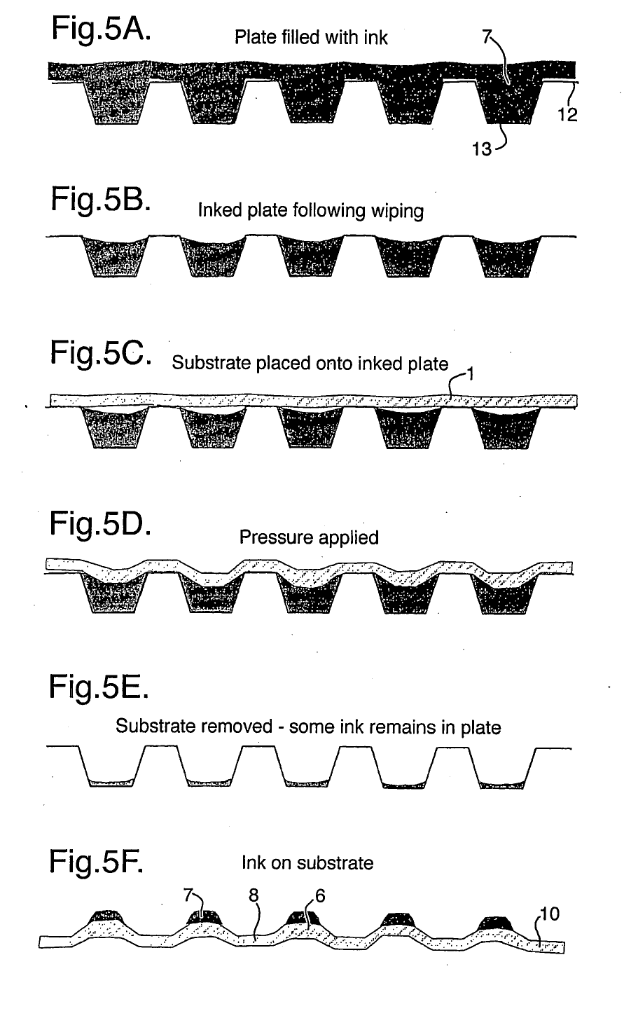

FIG. 5F is a schematic cross-section through part of a segment of the device shown in FIG. 2;

FIGS. 5A-5E illustrate different stages in the production of such a segment;

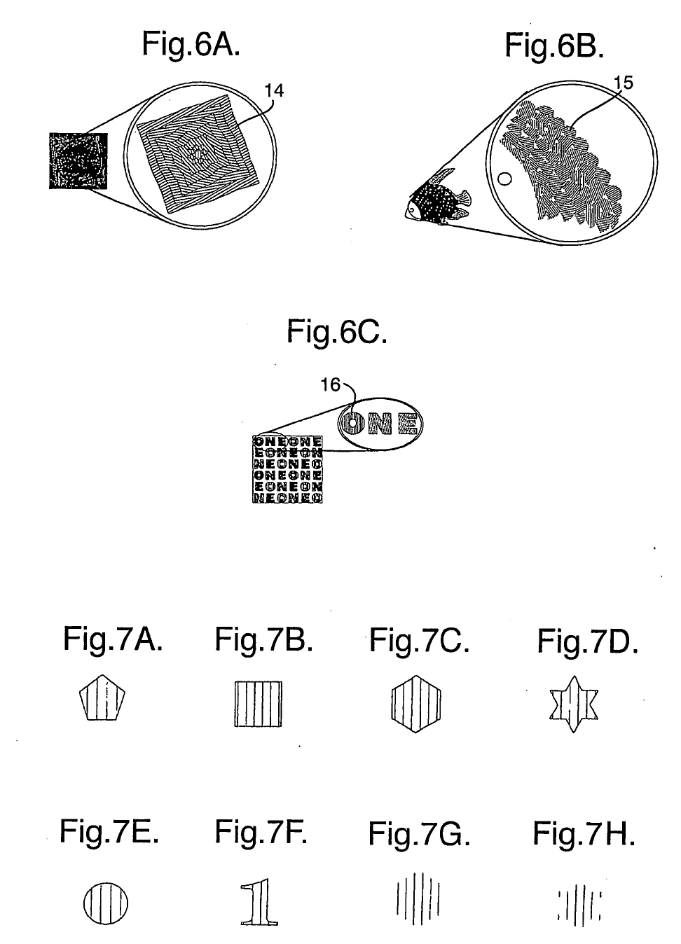

FIGS. 6A-6C illustrate further examples of a device according to the invention;

FIG. 7A-7H illustrate examples of segments of lines;

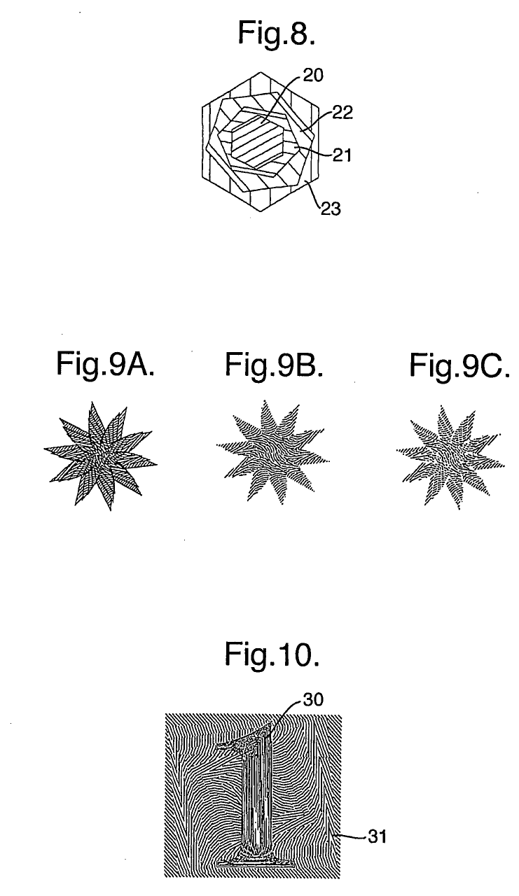

FIGS. 8 and 9A-9C illustrate nested arrangements of segments of lines;

FIG. 10 shows a further device; and,

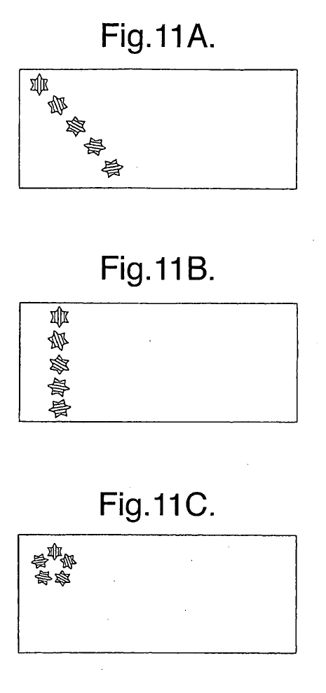

FIGS. 11A-11C illustrate three further devices.

FIG. 1 illustrates a banknote formed on a paper substrate 1 and carrying printing of a conventional type and in addition carrying an example of a security device 2 according to the invention. In this case, the security-device 2 has been intaglio printed directly onto a reflective portion of the banknote substrate and another part of the same intaglio printing plate has been used to print, at the same time, images (the portrait and indicia “De La Rue”, “2000”) indicated schematically at 3, so that these images are automatically and accurately registered with the device 2.

FIG. 1 shows the feature in the context of a banknote design with the feature numbered 2 and other printed intaglio regions numbered 3. Further to these printed intaglio regions other regions could be provided as uninked embossed areas, such as described in WO90/02658. FIG. 2 illustrates the device 2 in enlarged form. It will be noted that the number 2000 is not printed and it is also not embossed. This is a non-printing area on the intaglio plate within the area of the design. In addition, the device includes a first border made up of several indicia “2000” and an outer decorative border. All these regions are in register and printed from the same intaglio plate.

As explained above, the security device 2 can take a variety of forms and FIG. 3 illustrates one example. In this example, the-security device is made up of a variety of triangular 4 and square 5 shaped segments which are tessellated together. In this case, although a perimeter line is shown around each shape, this is, in fact, simply defined by the ends of the parallel lines making up the segments. The segments are each defined by a set of substantially parallel lines with the lines of different segments being angularly offset from one another.

Part of this security device is shown in enlarged form under different lighting conditions in FIGS. 4A to 4C. Thus, in FIG. 4A, the light is incident in a direction 9 and this will be reflected by the segments 5a and 4a-4d. This is because the lines in these segments extend at or near 90° to the incident light direction.

When the device is rotated so that the incident light direction is in a direction 10 (FIG. 4B), a different set of segments appears bright. In this case, the segments include segments 5b and 4e. Some of the segments appear less bright while the remaining segments appear dark. Again, this brightness depends upon how close the lines defining the segment extend at 90° to the incident light direction 10.

FIG. 4c illustrates a further angle of incidence 11 In which segments 4f-4m appear bright with the remaining segments appearing dark.

The top portion of each embossed line is covered with an ink as shown in FIG. 5F. Thus in this Figure, each embossed line of a substrate 1 is indicated at 6 with the ink at 7. As can be seen, the sides of each line are at an acute angle to a normal to the substrate and the valleys 8 between the summits of the lines 6 are free of ink but are reflective.

If the ink 7 is chosen to have a colour which contrasts with the reflective surface of the substrate 1 into which the lines have been embossed then the dark segments will exhibit the colour of the ink 7 in each case. Thus, as the security device shown in FIG. 3 is rotated relative to the incident light direction, the triangular shaped areas will switch on and off giving rise to an appearance of movement across the device as described in FIG. 4. This is a novel effect which is relatively easily detected by a user thus making it particularly suitable as a security device. Nevertheless, it is difficult to reproduce fraudulently. Thus this feature is much easier to authenticate than the latent type structure. It can also be easily located. As a secondary benefit, more with respect to OVDs, it is relatively cheap. As the feature can be produced using the existing litho and intaglio processes, the use of costly optically variable foils is avoided.

FIGS. 5A-5E illustrate different stages in the intaglio printing of the portion shown in FIG. 5F. Initially, an intaglio plate 12 having recesses 13 is coated with ink 7, the ink filling the recesses 13 and providing a surplus on the surface of the plate 12. This surplus is then wiped away in a conventional manner (FIG. 5B) and the substrate 1 placed onto the inked plate (FIG. 5C). Pressure is then applied between the plate 12 and substrate 1 (FIG. 5D) causing the substrate to enter the recesses 13. The substrate is then removed and draws with it most of the ink 7 contained within the respective recesses 13 but leaving a small remainder as can be seen in FIG. 5E. The resultant, printed substrate has the form shown in FIG. 5F.

A typical segment size is 2 mm by 2 mm or an equivalent area. By equivalent area we include the fact that the segment could be long and thin and could be a line bordering an area. For example in FIG. 6A each “segment”, such as 14, is, essentially a line around a square. In the figure drawn real size one can see that the width of this line is not that great but the line is quite long. Essentially the segments should be of a size and shape such that they can be visualised with the unaided eye. That is one should be able to discern the changing visual impression of each segment as viewing angle changes.

FIGS. 6B-6C illustrate further examples of arrangements of segments, such as 15 and 16.

FIGS. 7A to 7H illustrate a variety of other shapes which the segments can take. FIGS. 7A-7F show segments with a printed perimeter line in register with the embossed lines while FIGS. 7G and 7H show segments bounded only by the extent of the parallel lines. Multiple versions of segments shown in FIGS. 7G and 7H could be located adjacent one another but leaving a narrow unprinted line between them.

FIG. 8 illustrates an example of the security device in which a set of hexagonal shaped segments 20-23 are nested one within the other, each hexagon being rotated relative to the immediately adjacent inner and outer hexagons. Each hexagon 20-23 is defined by a set of lines with the angles of the lines being different and also their line widths and pitches. The segments could vary from 70 μm thick lines with 30 μm spacing progressively up to 150 μm thick lines with 75 μm spacing. As this security device is rotated, it will appear as a rotating hexagon which diminishes or expands in size. This is a particularly attractive but secure feature.

FIGS. 9A-9C illustrate further examples of nested segments. FIG. 9A shows a device with nested and rotated segments, the segments provided with a printed perimeter line. FIG. 9B shows a device with nested and rotated segments, the segments not provided with a perimeter line. FIG. 9C shows a device with nested and rotated segments, the segments provided with an unprinted perimeter line.

In the next example, a region is provided in the feature design on the intaglio plate which is deeper compared to the remainder of the feature design. This will in turn equate to a region that has a greater relief when printed. To explain this, consider the design of security device shown in FIG. 10. The design shown in FIG. 10 comprises two elements: a background 31 of nested segments all rotated with respect to each other, and a central numeral 1 indicated by reference 30. In this simple example the central numeral 1 can be originated such that the intaglio plate was deeper in this area compared to the surrounding nested segments.

In a different example, using a structure such as that shown in FIG. 6A, a latent effect may be created. Here the feature comprises only a series of nested segments rotated with respect to each other with no apparent secondary element. Indeed if originated as per normal practice one would still only have the one feature as already described. But it is possible to selectively produce deeper regions on the plate and thus produce an area in a defined shape (say a numeral 1) that is deeper than the surrounding area. This would not be readily recognisable under normal viewing but should be viewable when the device is viewed at an acute angle. One example of how this might be achieved using the polymer process is given below.
1. Exposure through the line structure film work onto photopolymer as usual.
2. Carry out a first wash out of say 10 seconds to give a depth of, for example, 50 microns to produce a photopolymer with the line structure having a nominally consistent depth of 50 microns.
3. Carry out a second exposure using a solid design; say a numeral 1 or a pattern. The photopolymer will be hardened everywhere except where masked by the numeral 1 or pattern.
4. Carry out a second wash out. Where the plate has been hardened further no further washing out of the photopolymer occurs however in the numeral/pattern region which was subject to the further exposure additional photopolymer is washed out resulting in a deeper engraving say 70 microns.

Other known techniques could be used to produce the intaglio plate such as mechanical or laser origination techniques. For example as disclosed in EP-A-0906193 and WO-A-03/103962.

As explained throughout, where intaglio printing is used to produce the security device, it is possible to provide uninked embossed areas as well as printed ink areas using the same plate.

FIG. 11 illustrates some further examples of banknotes (shown schematically) carrying security devices. In FIG. 11A, the device comprises a line of star shapes each fabricated in the manner shown in FIG. 7D but with different line orientations.

FIGS. 11B and 11C illustrate vertical and circular arrangements of star shapes.

1. A security device comprising a substrate having a reflective portion which is provided with a raised line structure, the line structure defining a plurality of segments, each segment being formed by a respective set of substantially parallel raised lines, the lines of at least three segments extending in different directions, each line being formed by or carrying an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.

2. A device according to claim 1, wherein the substantially parallel lines within a segment are straight or curved.

3. A device according to claim 1, wherein the substantially parallel lines within a segment are discontinuous.

4. A device according to claim 1, wherein the substantially parallel lines of adjacent segments extend in different directions.

5. A device according to claim 1, wherein the substantially parallel lines within a segment have substantially the same width and/or height and/or pitch.

6. A device according to claim 1, wherein the segments have the same shape.

7. A device according to claim 1, wherein the segments define geometric shapes or alphanumeric indicia.

8. A device according to claim 6, wherein the segments defining the same shape are nested one within the other.

9. A device according to claim 8, wherein the segments are rotated relative to one another.

10. A device according to claim 1, wherein a group of the segments are defined and arranged relative to one another so as to define an image such as a geometric shape or alphanumeric indicia.

11. A device according to claim 1, wherein the segments abut one another.

12. A device according to claim 1, wherein the ink colour (or colours) is different from the colour of the reflective portion.

13. A device according to claim 1, wherein the raised line structure is embossed or debossed into the substrate.

14. A device according to claim 13, wherein parts of the lines are uninked.

15. A device according to claim 1, wherein the reflective portion is formed by one of a foil, metallic ink, metallic coating, iridescent coating, glossy varnish, hologram or holographic coating.

16. A device according to claim 1, wherein the reflective portion is discontinuous.

17. A device according to claim 1, wherein the line widths are in the range of 10-300 microns, preferably 50-150 microns.

18. A device according to claim 1, wherein the space between adjacent lines is in the range 10-300 microns.

19. A device according to claim 1, wherein the line width to space ratio is typically 3:1 to 1:2, preferably 2:1.

20. A device according to claim 1, wherein the raised line structure extends beyond the reflective portion.

21. A device according to claim 1, wherein the reflective portion extends beyond the raised line structure.

22. A device according to claim 1, wherein the device further comprises a printed border.

23. A device according to claim 22, wherein the border is in register with the raised line structure.

24. A device according to claim 23, wherein the border and raised line structure have been printed using different parts of the same printing plate.

25. A device according to claim 1, wherein the substrate comprises one of uncoated paper, coated paper, and a plastic.

26. A device according to claim 1, wherein the substrate forms part of a document of value.

27. A document of value carrying a security device according to claim 1.

28. A document of value according to claim 27, wherein the security device is adhered to the document.

29. A device or document of value according to claim 26, wherein the document of value comprises a banknote.

30. A method of manufacturing a security device, the method comprising providing a reflective surface portion of a substrate with a raised line structure, the line structure defining a plurality of segments, each segment being formed by a respective set of substantially parallel raised lines, the lines of at least three segments extending in different directions, and providing each line with an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.

31. A method according to claim 30, wherein the lines are embossed, the embossing step being carried out using an intaglio plate having recesses defining the line structure which are filled with the ink.

32. A method according to claim 30, wherein the printing plate used to define the lines also defines a further image separate from the security device.

33. A method for manufacturing the security device according to claim 1, the method comprising providing a reflective surface portion of a substrate with a raised line structure, the line structure defining a plurality of segments, each segment being formed by a respective set of substantially parallel raised lines, the lines of at least three segments extending in different directions, and providing each line with an ink which does not extend fully into the spaces between the lines or which is sufficiently translucent between the lines so as not to obscure the reflective surface between the lines, wherein each segment causes incident light to be reflected in a variable manner as the angle of incidence changes.

34. A security device comprising a substrate having a reflective portion which is provided with a raised line structure, the line structure defining a plurality of segments, each segment being formed by a respective set of substantially parallel embossed lines, the lines of at least five segments extending in different directions, wherein each segment causes incident light to be reflected non-diffractively in a variable manner as the angle of incidence changes.

35. A banknote carrying a security device according to claim 1, manufactured by a method comprising providing a reflective surface portion of a substrate with a raised line structure, the line structure defining a plurality of segments, each segment being formed by a respective set of substantially parallel raised lines, the lines of at least three segments extending in different directions, and providing each line with an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.

36. A banknote carrying a security device according to claim 34, manufactured by a method comprising providing a reflective surface portion of a substrate with a raised line structure, the line structure defining a plurality of segments, each segment being formed by a respective set of substantially parallel raised lines, the lines of at least three segments extending in different directions, and providing each line with an ink which does not extend fully into the spaces between the lines or which is sufficiently translucent between the lines so as not to obscure the reflective surface between the lines, wherein each segment causes incident light to be reflected non-diffractively in a variable manner as the angle of incidence changes.
